(19) United States
(12) Patent Application Publication
(10) Pub. No.: US 2002/0019717 A1
(43) Pub. Date: Feb. 14, 2002

(54) Method for correcting wheel speed

(76) Inventor: Kazuma Uchida, Shizuoka-ken (JP)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/872,768

(22) Filed: Jun. 1, 2001

(30) Foreign Application Priority Data
Jun. 5, 2000 (JP) 2000-167572

(51) Int. Cl. G06F 17/00; B60T 7/12

(52) U.S. Cl. 702/96; 701/75; 701/79

(57) ABSTRACT

A method for correcting wheel speed comprising determining the measured wheel speed and a slip ratio based on signals from the respective wheel speed sensors; determining a reference wheel speed among the measured wheel speeds of the respective wheels; periodically obtaining a correction factor, to be multiplied by the measured wheel speed to determine a corrective wheel speed, so as to arrange the corrective wheel speed close to the reference wheel speed; setting an initial value of the correction factor in such a way to reduce the slip ratio based on a diameter of a tire; and determining the corrective wheel speed by multiplying the correction factor by the measured wheel speed. It is an object of this invention to provide an appropriate and precise correction of wheel speed regardless of an existence of a non-standard tire, such as a mini-tire.

### TECHNICAL FIELD

The present invention relates to methods for correcting wheel speed on a vehicle with a non-standard tire, such as a mini-tire.

### BACKGROUND OF THE INVENTION

A traditional correction system corrects wheel speed by comparing the respective wheel speeds while a vehicle is driving. Therefore, if significant differences between wheel speeds already exist upon or immediately following ignition, the traditional correction system has a problem making appropriate corrections to wheel speeds, thereby resulting in malfunction.

Alternatively, there exists a traditional method of setting a wider range of threshold values for activating the control in order to avoid such malfunctioning at the initial stage. However, this method has a problem of reducing effectiveness of the brake control.

### SUMMARY OF THE INVENTION

The present invention is directed toward preventing a brake control malfunction in cases where significant differences exist between vehicle wheel speeds upon or immediately after ignition, without reducing the brake control performance, and toward improving the brake control performance by accurately correcting the wheel speeds. An embodiment of the invention provides a method for correcting wheel speed in a vehicle control system having a wheel speed sensor for detecting the rotational speed of a wheel, and an electronic control device for receiving a signal from the wheel speed sensor and conducting a calculation. The method comprises determining a measured wheel speed and a slip ratio based on signals from the respective wheel speed sensors; selecting a reference wheel speed from the measured wheel speeds of the respective wheels; obtaining a correction factor, to be multiplied by the measured wheel speed to determine a corrective wheel speed, periodically so as to arrange the corrective wheel speed close to the reference wheel speed; setting an initial value of the correction factor in such a way as to reduce the slip ratio based on a diameter of a mini-tire; and determining the corrective wheel speed by multiplying the correction factor by the measured wheel speed.

This invention further can comprise a method for correcting wheel speed as above, wherein the correction factor is periodically adjusted by adding or subtracting a predetermined value so as to make the corrective wheel speed close to the reference wheel speed.

This invention still further can comprise a method for correcting wheel speed as above, wherein the corrective wheel speed is set to be the reference wheel speed if the correction factor is less than 1 and the corrective wheel speed is lower than the reference wheel speed.

This invention still further can comprise a method for correcting wheel speed as above, wherein the corrective wheel speed is set to be the reference wheel speed if the correction factor is more than 1 and the corrective wheel speed is higher than the reference wheel speed.

This invention still further can comprise a method for correcting wheel speed as above, wherein with respect to the correction factors of the measured wheel speed closest to the reference wheel speed, an amount of correction to be included in the correction factor of the tire approaching one (1) from an initial value is to be larger than an amount of correction to be added on the correction factors of each other wheels.

This invention yet further can comprise a method for correcting wheel speed as above, wherein the corrective wheel speed of the reference wheel speed is always equal to the measured wheel speed.

### DESCRIPTION OF THE DRAWINGS

The above and other objects and the attendant advantages of the present invention will become readily apparent by reference to the following detailed description when considered in conjunction with the accompanying drawings wherein:

FIG. 1 is an elevation view schematically showing brake fluid channels of a vehicle according to an embodiment of the present invention;

FIG. 2 is a schematic drawing showing a hydraulic pressure circuit of a vehicle according to an embodiment of the present invention; and

FIGS. 3A and 3B are block diagrams schematically illustrating a method according to an embodiment of the present invention.

### DETAILED DESCRIPTION OF THE ILLUSTRATED EMBODIMENTS

An embodiment of this invention is explained with reference to the accompanied drawings.

Vehicle Brake Control System

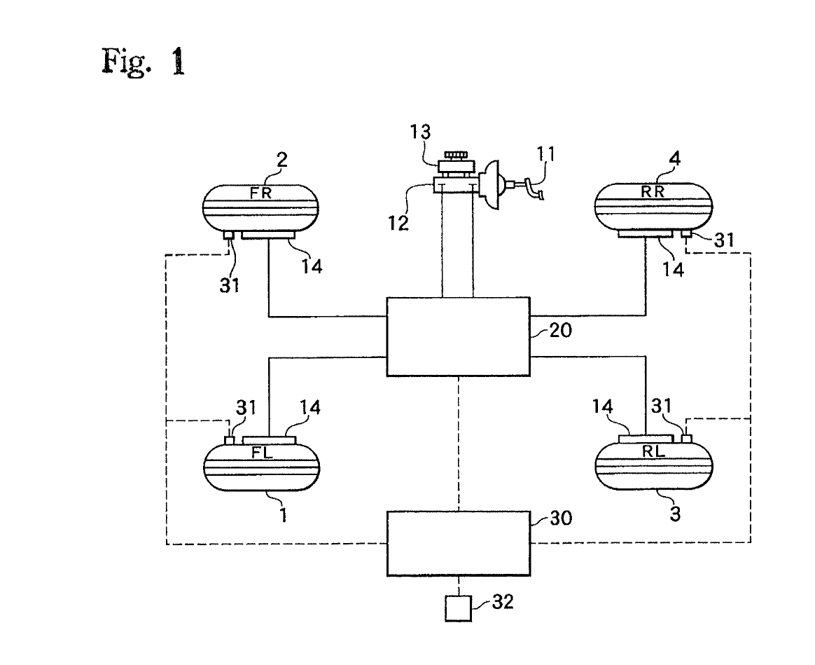

A vehicle brake control system, for example the brake control system illustrated in FIG. 1, comprises an electronic control device 30 and a hydraulic unit. The electronic control device 30 sends commands to the various brake control systems, such as the anti-lock brake control and the traction control, by determining wheel speed, acceleration, deceleration, and estimated vehicle speed. The hydraulic unit performs based on the control command from the electronic control device 30. Hydraulic pressure generated at a brake pedal 11, a main reservoir 13, and a master cylinder 12 is connected by hydraulic channels to four wheel cylinders 14 associated with the respective wheels (i.e., a left front wheel 1, a right front wheel 2, a left rear wheel 3, and a right rear wheel 4).

A rotational speed of the respective wheels 1, 2, 3, 4 is measured by a wheel speed sensor 31 and a corresponding signal is input in the electronic control device 30. This signal can be used to calculate wheel speed, acceleration and deceleration, or slip ratio. Signals from a G sensor 32 can also be input in the electronic control device 30, and the vehicle acceleration and deceleration can be calculated using the G sensor. The electronic control device 30 can incorporate special hardware and general computing devices, such as a microprocessor or micro computer.

Hydraulic Unit

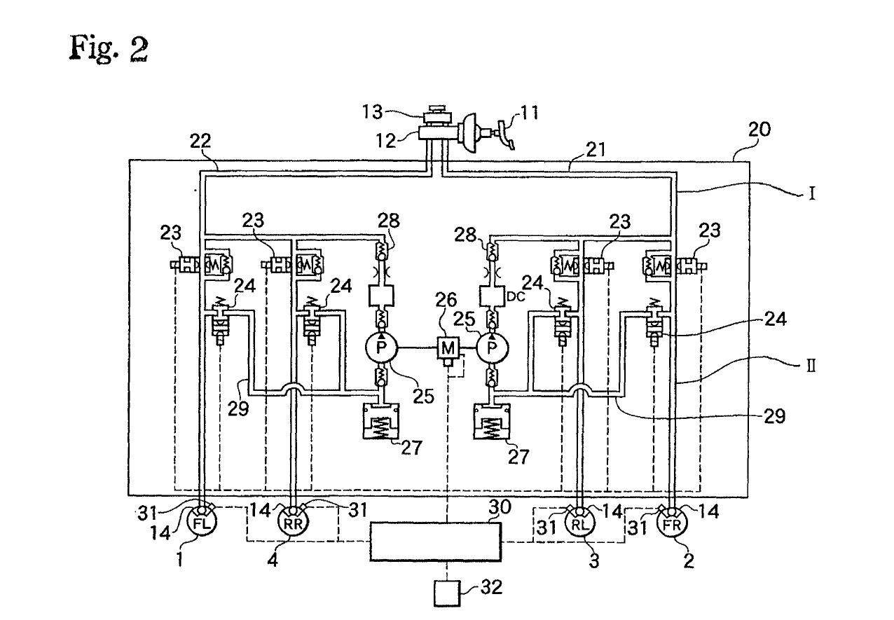

An example of the hydraulic unit 20 is shown in FIG. 2, which illustrates a hydraulic circuit for a brake control system, such as the anti-lock brake control system (ABS) or the traction control system. FIG. 2 shows an example of X piping, i.e., where a first hydraulic circuit 21 is connected to the right front wheel 2 and the left rear wheel 3, while a second hydraulic circuit 22 is connected to the left front wheel 1 and the right rear wheel 4. The hydraulic unit 20 comprises main hydraulic channels I, II that connect the master cylinder 12 to the respective wheel cylinders 14 via inlet valves 23, and that connect a return channel from the respective wheel cylinders 14 via outlet valves 24. The hydraulic unit 20 also comprises auxiliary reservoirs 27, and pumps 25 to the main hydraulic channel I. The hydraulic unit 20 controls the opening and closing of the inlet and outlet valves 23, 24 and controls a pump to provide a certain brake control. The main reservoir 13 accumulates a brake fluid. A check valve 28 prevents a reverse flow. A motor 26 conducts driving control.

Measured Wheel Speed and Acceleration and Deceleration

Wheel speed of the respective wheels 1, 2, 3, 4 is measured based on a wheel rotation at the electronic control device 30 according to signals from the wheel speed sensors 31 set in the wheels. Therefore, if a standard tire is replaced by a tire having a different diameter, e.g., by a mini-tire with a smaller diameter, a value of the measured wheel speed determined by the electronic control device changes. For instance, if a standard tire is in fact switched to a mini-tire, a rotational speed of the wheel increases under identical driving speeds, thereby increasing the measured wheel speed. A vehicle acceleration and deceleration may be determined from the amount of change in unit time.

Calculating a Slip Ratio

Slip ratio is a ratio of slip in relation to a wheel and a road surface. For example, the slip ratio is equal to (wheel speed-vehicle speed)/vehicle speed. The measured wheel speed may be used as the wheel speed, and the estimated vehicle speed may be used as the vehicle speed. The estimated vehicle speed may be calculated by utilizing the wheel speed and a G sensor, and for example, in case of a two-wheel drive vehicle, the estimated vehicle speed may be estimated from the measured wheel speed of a non-driving wheel while in case of a four-wheel drive vehicle it may be estimated in consideration of the highest wheel speed and an output value of the G sensor.

Anti-Lock Brake Control

The electronic control device 30 determines a condition of a wheel by receiving signals from sensors, such as a wheel speed sensor 31, and calculates for example a wheel slip ratio and a wheel deceleration. If wheels are locked upon braking and the slip ratio and wheel deceleration go beyond threshold values, an anti-lock brake control may be activated. The anti-lock brake control may operate by opening and closing the inlet valve 23 and the outlet valve 24 and driving the pump 25 by the motor 26. In the anti-lock brake control, a brake hydraulic pressure may be cyclically increased and decreased. In a pressure increase mode of one cycle, for example, opening and closing control is conducted in the inlet valve 23 and the outlet valve 24 is closed to increase the brake hydraulic pressure of a wheel cylinder 14.

Traction Control

When the wheel speed is increased, the traction control optimizes the control of the braking force relative to the road surface, and controls the brake hydraulic pressure of the wheel based on the level of slip. For instance, if the slip ratio showing the slip level is at or above a threshold value, a traction control correction may be conducted. In a traction control correction, the brake hydraulic pressure may be sequentially cycled through a pressure increase mode increasing the brake hydraulic pressure, a pressure hold mode holding the brake hydraulic pressure at the increased level, and a pressure reduction mode reducing the brake hydraulic pressure.

Wheel Speed Correction

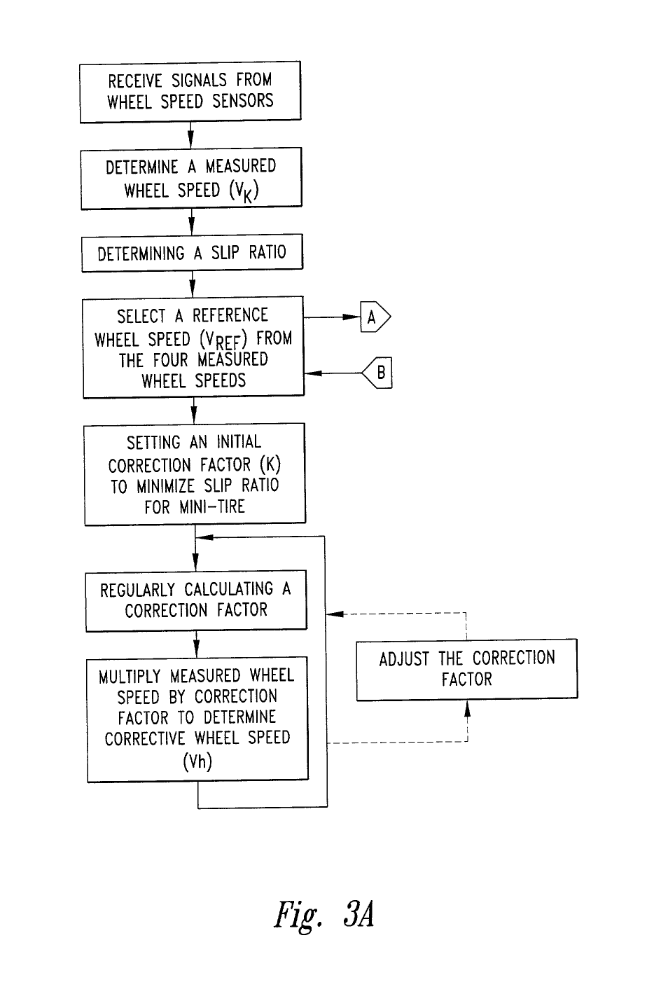

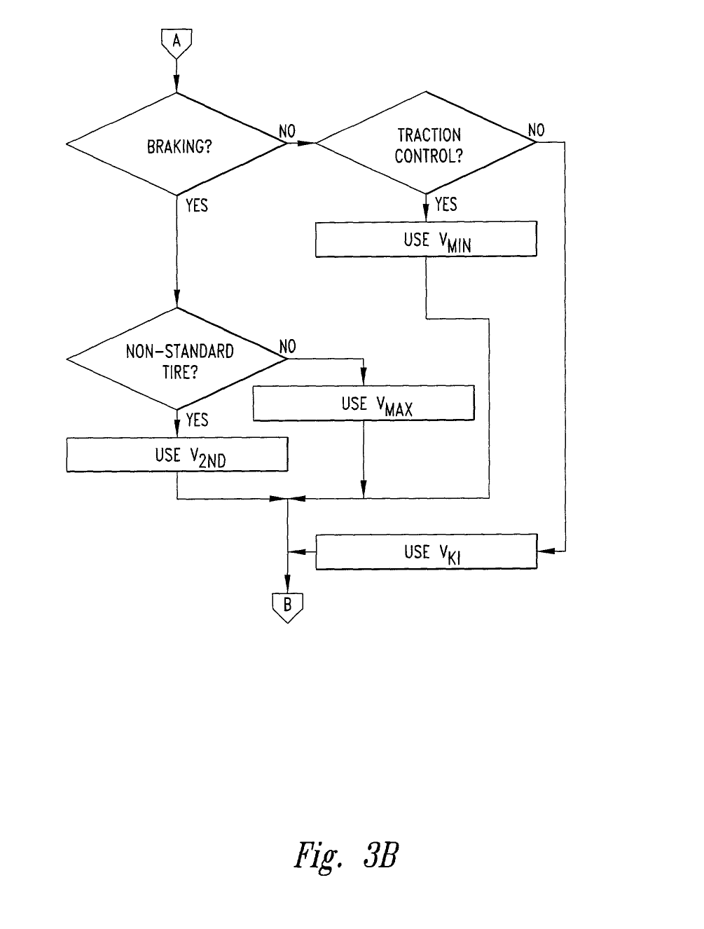

A corrective wheel speed is not determined by checking each of the wheels to determine whether it has mounted to it a mini-tire. The corrective wheel speed is instead determined by detecting the measured wheel speeds of the four wheels and correcting the measured wheel speeds based on differences between the four measured wheel speeds. This determination is made without considering whether the wheel speed is affected by differences of the diameters of the four wheels. One particular embodiment of this method is schematically illustrated in FIG. 3.

Measuring the Measured Wheel Speed

The measured wheel speed (Vk) of each wheel is determined by processing signals from the respective wheel speed sensors. The measured wheel speed can correspond to a number of wheel rotations during a predetermined amount of time.

Selecting the Reference Wheel Speed

The reference wheel speed (Vref) is selected from the measured wheel speeds of the four wheels. For example, in the case of the anti-lock brake control being applied, the reference wheel speed (Vref) is presumed to be the measured wheel speed closest to the vehicle speed. Therefore, during anti-lock braking, the reference wheel speed (Vref) is the maximum measured wheel speed (Vmax).

If a tire having a non-standard diameter, such as a mini-tire, is installed on a vehicle, a second fastest measured wheel speed (V2nd) is presumed to be the closest to the vehicle speed. In such a case, the second fastest measured wheel speed (V2nd) is selected to be the reference wheel speed (Vref).

Further, for the traction control system, the minimum measured wheel speed (Vmin) is presumed to be the closest to the vehicle speed. In such a case, the reference wheel speed (Vref) is set to be the minimum measured wheel speed (Vmin).

Method for Correcting the Measured Wheel Speed

Measured wheel speed (Vk) is first determined for each wheel, i.e., Vk1, Vk2, Vk3, Vk4. Then the reference wheel speed (Vref) is selected. If the reference wheel speed (Vref) is the measured wheel speed of the front left wheel, i.e. V1, the measured wheel speed Vk (Vk1, Vk2, Vk3, Vk4) will be multiplied by a correction factor K (K1 =1, K2, K3, K4) as in Formulas 1-4, to determine the corrective wheel speed Vh (Vh1, Vh2, Vh3, Vh4).

FORMULA 1

Vh1=Vref=1×Vk1

FORMULA 2

Vh2=K2×Vk2

FORMULA 3

Vh3=K3×Vk3

FORMULA 4

Vh4=K4×Vk4

Adjustment of Correction Factor

The correction factor is initialized at every wheel when the vehicle's ignition is turned on. The initial value of the correction factor is determined to prevent the antilock brake control system and the traction control system from malfunctioning due to the presence of a non-standard sized tire, such as a mini-tire. That is, the initial value is determined so as to reduce the slip ratio recognized by the system.

For example, assuming there is a mini-tire installed on the vehicle, the initial value of the correction factor is set so as to adjust the wheel speed of the mini-tire to be equal to the wheel speed of a wheel with standard diameter. That is, since a wheel with a relatively higher speed is controlled in a traction control scenario, if the diameter of the mini-tire is 10% smaller than the normal tire, by setting the initial value of the correction factor for the smaller wheel to approximately 0.9, the system sees no significant difference between the reference wheel speed and the corrective wheel speed regardless of the existence of the mini-tire from the time immediately after the ignition is turned on, thereby preventing system malfunction.

On the other hand, since a wheel with a relatively lower speed is controlled in an anti-lock brake control scenario, if the diameter of the mini-tire is 10% smaller than the normal tire, by setting the initial value of the correction factor for the larger (standard) wheels to be approximately 1.1, no significant difference between the reference wheel speed and the corrective wheel speed will be noticed, regardless of the existence of the mini-tire, from the time immediately after the ignition is turned on, thereby preventing system malfunction.

The correction factor is changed periodically for an adjustment such that the corrective wheel speed comes closer to the reference wheel speed (Vref). In case the reference wheel speed (Vref) is set to be a minimum measured wheel speed (Vk1), as in the traction control, the correction factor (VK1) of the reference wheel speed (Vref) is corrected to approach 1 as appeared for example in a first equation of Formula 5 and the corrective wheel speed (Vh1) is set to be the measured wheel speed to be determined by a second equation of Formula 5. The corrective wheel speeds of the other three wheels may be determined by Formula 6 and Formula 7. Further, if the reference wheel speed (Vref) is set to be a maximum measured wheel speed (VK1) as in the antilock brake control, the correction factor (VK1) of the reference wheel speed (Vref) is corrected to approach 1, for example, as determined by Formula 8. The corrective wheel speeds of the other three wheels may be determined by Formula 9 and Formula 10. Here, if the corrective wheel speed becomes more than the reference wheel speed (Vref), the corrective wheel speed is set to be the reference wheel speed (Vref). As such, the corrective wheel speed is adjusted to the adjusted correction factor is used for the correction of the wheel speed. A correction period is determined as appropriate, and for example it may be 0.9 seconds per period.

FORMULA 5

K1=K1+a

but maximum value of “a”=1

Vh1=VK1=Vref

FORMULA 6

VK1≦Vk2≦Vk2≦Vk4

if Vh2=K2×Vk2<Vref, Vh2=Vref, K2=K2+a

if Vh3=K3×Vk3<Vref, Vh3=Vref, K3=K3+b

if Vh4=K4×Vk4<Vref, Vh4=Vref, K4=K4+b

but minimum value of K2, K3, K4=initial value

e.g., “a” is 0.005 and “b” is 0.001

FORMULA 7

VK1≦Vk2≦Vk2≦Vk4

if Vh2=K2×Vk2≧Vref, K2=K2−c

if Vh2=K3×Vk3≧Vref, K3=K3−c

if Vh4=K4×Vk4≧Vref, K2=K4−c

but maximum value of K2, K3, K4=1

e.g., “C” is 0.001

FORMULA 8

K1=K1−d

minimum value of d=1

Vh1=VK1=Vref

FORMULA 9

VK1≧Vk2≧Vk2≧Vk4

if Vh2=K2×Vk2>Vref, Vh2=Vref, K2=K2−d

if Vh3=K3×Vk3>Vref, Vh3=Vref, K3=K3−e

if Vh4=K4×Vk4>Vref, Vh4=Vref, K4=K4−e

but minimum value of K2, K3, K4=1

e.g., “d” is 0.005 and “e” is 0.001

FORMULA 10

VK1≧Vk2≧Vk2≧Vk4

if Vh2=K2×Vk2≦Vref, K2=K2+f

if Vh2=K3×Vk3≦Vref, K3=K3+f

if Vh4=K4×Vk4≦Vref, K2=K4+f

but maximum value of K2, K3, K4=1

e.g., “f” is 0.001

Early correction of wheel speed immediately after the ignition is turned on

With respect to two wheels (one with the measured wheel speed being the reference wheel speed and the other with the measured wheel speed being the wheel speed closest to the reference wheel speed), if “a” or “d” of the correction factor is set to be larger than “b” or “e” of other measured wheel speed, the correction factor of the reference wheel speed and the wheel speed closest to the reference wheel speed may quickly get closer to 1 from the initial value set so as to prevent malfunctioning due to a mini-tire immediately after the ignition is turned on.

In a normal situation where no mini-tire is installed, four measured wheel speeds should be approximately the same. In such a case, since the vehicle makes turns and wheel speeds vary due to various conditions, the number of times every wheel is selected as the reference wheel speed or the wheel speed closest to the reference wheel speed is approximately equal for all four wheels. Accordingly, in the normal situation, four wheels together become a normal value, i.e., I much quicker from the initial value immediately after the ignition is turned on.

On the other hand, in a situation where a tire with a non-standard diameter, i.e., a mini-tire, is installed, the particular mini-tire does not become the reference wheel speed or the wheel speed closest to the reference wheel speed, or at most rarely becomes the reference wheel speed or the wheel speed closest to the reference wheel speed. Therefore, even if the vehicle has the mini-tire, the correction factor of the wheel with a mini-tire is restricted to be within an appropriate range and should not deviate causing a control malfunction due to an inappropriate correction. At the same time, tires with standard diameters equally become the reference wheel speed or the wheel speed closest to the reference wheel speed, thereby being adjusted to be the normal value, i.e., 1 and offering an appropriate brake control.

Accordingly, normally the adjustment of the amount of “a” or “b” determines the time of completing the correction, i.e., from the initial value to the appropriate value, while the adjustment of the amount of “c” or “d” functions for fine adjustment after the completion of the correction. Hence, “a” or “b” may be set to be larger while “C” or “f” to be smaller so as to quickly adjust to an appropriate value immediately after the ignition is turned on and to prevent speed variation afterward. Especially, the amount of correction relative to an outer wheel while turning is small, thereby not being affected by turning. Further, the amount of correction for the inner and outer wheels while turning should be same. Therefore, even if the vehicle is turning, the system maintains the diagonal differences ×((left front wheel speed−right rear wheel speed)−(right front wheel speed-left rear wheel speed))=0, thereby maintaining the balance of wheels and enabling to use the diagonal differences as one of the indexes for wheel slip for the brake control.

Embodiments of this invention can prevent a malfunction in a brake control system caused by significant differences in wheel speeds at an initial stage immediately after ignition, regardless of the presence of a non-standard sized tire causing the significant wheel speed differences. In addition, further corrections allow appropriate and precise corrections of wheel speed, thereby improving controllability.

It is readily apparent that the above-described invention has the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the scope of the invention.

What we claim is:

1. A method for correcting a wheel speed used in a vehicle control system comprising a wheel speed sensor that detects a rotational speed of a wheel and an electronic control device that receives a signal from the wheel speed sensor, the method comprising:
determining a measured wheel speed and a slip ratio based on signals from the respective wheel speed sensors;
determining a reference wheel speed among the measured wheel speeds of the respective wheels;
periodically obtaining a correction factor, the correction factor to be multiplied by the measured wheel speed to determine a corrective wheel speed, so as to arrange said corrective wheel speed close to said reference wheel speed;
setting an initial value of the correction factor in such a way to reduce the slip ratio based on a diameter of an odd-sized tire; and
determining the corrective wheel speed by multiplying the correction factor by the measured wheel speed.

2. A method for correcting wheel speed as claimed in claim 1 wherein the correction factor is periodically adjusted by adding or subtracting a predetermined value so as to make the corrective wheel speed close to the reference wheel speed.

3. A method for correcting wheel speed as claimed in claim 1 wherein the corrective wheel speed is set to be the reference wheel speed if the correction factor is smaller than one (1) and the corrective wheel speed is lower than the reference wheel speed.

4. A method for correcting wheel speed as claimed in claim 1 wherein the corrective wheel speed is set to be the reference wheel speed if the correction factor is larger than one (1) and the corrective wheel speed is higher than the reference wheel speed.

5. A method for correcting wheel speed as claimed in claim 1 wherein with respect to the correction factor of the measured wheel speed closest to the reference wheel speed, an amount of correction to be included in the correction factor of the tire approaching one (1) from an initial value is to be larger than an amount of correction to be included in the correction factors of each other wheels.

6. A method for correcting wheel speed as claimed in claim 1 wherein the corrective wheel speed of the reference wheel speed is equal to the measured wheel speed.

7. A method for adjusting a rotational speed of a vehicle wheel having an oddsized tire, the method comprising:
obtaining measured wheel speeds corresponding to the respective rotational speeds of more than one of the vehicle's wheels;
selecting a reference wheel speed from the measured wheel speeds;
setting a correction factor to a predetermined initial correction factor, the initial correction factor being selected to at least reduce a slip ratio of the wheel based on a diameter of the odd-sized tire;
calculating a corrective wheel speed for the wheel by multiplying the correction factor and the measured wheel speed; and
adjusting the rotational speed of the wheel from the measured wheel speed to the corrective wheel speed.

8. The method of claim 7 wherein the correction factor is periodically adjusted by adding or subtracting a predetermined value to cause the corrective wheel speed to approach the reference wheel speed.

9. The method of claim 7 wherein the corrective wheel speed is selected to approximate the reference wheel speed when the correction factor is less than one (1) and the corrective wheel speed is less than the reference wheel speed.

10. The method of claim 7 wherein the corrective wheel speed is selected to approach the reference wheel speed when the correction factor is greater than one (1) and the corrective wheel speed is greater than the reference wheel speed.

11. The method of claim 7 wherein with respect to the correction factor of the measured wheel speed closest to the reference wheel speed, an amount of correction to be included in the correction factor of the tire approaching one (1) from an initial value is to be larger than an amount of correction to be included in the correction factors of each other wheels.

12. The method of claim 7 wherein the corrective wheel speed of the reference wheel speed is equal to the measured wheel speed.

13. A system for adjusting a rotational speed of a vehicle wheel having an oddsized tire, the system comprising:
means for obtaining measured wheel speeds corresponding to the respective rotational speeds of more than one of the vehicle's wheels;
means for selecting a reference wheel speed from the measured wheel speeds;
means for setting a correction factor to a predetermined initial correction factor, the initial correction factor being selected to at least reduce a slip ratio of the wheel based on a diameter of the odd-sized tire;
means for calculating a corrective wheel speed for the wheel by multiplying the correction factor and the measured wheel speed; and
means for adjusting the rotational speed of the wheel from the measured wheel speed to the corrective wheel speed.
